(19) United States
(12) Patent Application Publication
(10) Pub. No.: US 2014/0304935 A1
(43) Pub. Date: Oct. 16, 2014

(54) WINDSCREEN WIPER DEVICE

(71) Applicant: Federal-Mogul Corporation, Southfield, MI (US)

(72) Inventors: Michael Oslizlo, Commerce Twp., MI (US); Danielle Jankowski, Dearborn, MI (US)

(73) Assignee: Federal-Mogul Corporation, Southfield, MI (US)

(21) Appl. No.: 14/252,296

(22) Filed: Apr. 14, 2014

Related U.S. Application Data
(60) Provisional application No. 61/811,566, filed on Apr. 12, 2013.

(51) Int. Cl. B60S 1/38

(52) U.S. Cl. CPC B60S 1/3863; B60S 1/3886; B60S 2001/3898; B60S 2001/3843
USPC 15/250.201; 156/60; 156/290

(57) ABSTRACT

A windscreen wiper device is provided. The wiper device includes a longitudinally extending wiper blade of a flexible material for sealing against a windshield of a vehicle. An elastic, elongated carrier that is self-biased into a pre-curved shape and which extends longitudinally between opposite ends operably supports and biases the wiper blade into a pre-curved configuration. A connecting device is secured to the carrier for attachment to an oscillating wiper arm. A pair of subspoilers, which are constructed as separate pieces from one another and from the wiper blade, are arranged on longitudinally opposite sides of the connecting device. Each of the subspoilers is joined with the carrier along less than a full longitudinal length of the respective subspoiler with an adhesive.

### CROSS-REFERENCE TO RELATED APPLICATION

This application claims the benefit of application Ser. No. 61/811,566, which was filed on Apr. 12, 2013.

### BACKGROUND OF THE INVENTION

1. Field of the Invention

The present invention is related, generally, to beam style wiper blades and more particularly to beam style wiper blades with one or more flexors and a spoiler.

2. Related Art

Beam-style wiper blades are becoming increasingly common increasingly in the wiper blade industry. Typical beam-style wiper blade assemblies include a longitudinally extending wiper blade for sealing against a windshield, a carrier element which operably supports the wiper blade and a connecting device for joining the wiper blade assembly with an oscillating wiper arm of a vehicle. Some wiper blade assemblies additionally include a spoiler for applying a downforce to bias the wiper blade against the windshield of the vehicle when the vehicle is travelling at speed to improve the seal established between the wiping element and the windshield and ensure proper performance of the wiper blade assembly.

### SUMMARY OF THE INVENTION AND ADVANTAGES

According to an aspect of the present invention, a windscreen wiper device is provided including a longitudinally extending wiper blade of a flexible material for sealing against a windshield of a vehicle. The wiper device further includes an elastic, elongated carrier that is self-biased into a pre-curved shape and which extends longitudinally between opposite ends. The carrier operably supports and biases the wiper blade into a pre-curved configuration. A connecting device is secured to the carrier for attachment to an oscillating wiper arm. A pair of subspoilers, which are constructed as separate pieces from one another and from the wiper blade, are arranged on longitudinally opposite sides of the connecting device, and each of the subspoilers is joined with the carrier along less than a full longitudinal length of the respective subspoiler with an adhesive. This may be advantageous from an operational perspective by allowing for improved flexing and unflexing of the windscreen wiper device as it oscillates back and forth on a curved windshield during operation of a vehicle's wiping system.

According to another aspect of the present invention, each of the subspoilers is joined with the carrier in at least three discrete and spaced apart adhesive regions which are spaced apart by at least two non-adhesive regions.

According to yet another aspect of the present invention, a pair of end caps are joined to opposite longitudinal ends of the carrier and are longitudinally spaced from the connecting device.

According to still another aspect of the present invention, each of the subspoilers substantially spans the space between the connecting device and one of the end caps.

According to a further aspect of the present invention, the adhesive joining the subspoilers is a glue.

According to yet a further aspect of the present invention, each of the subspoilers has a base surface and a pair of claws which engage around opposite lateral sides of the carrier and are adhesively joined to the carrier.

According to still a further aspect of the present invention, the base surface is adhesively joined to at least one of the wiper blade and the carrier.

Another aspect of the present invention provides for a method of making a windscreen wiper device. The method includes the step of preparing a wiper blade of a flexible material for sealing against a windshield to be cleaned. The method proceeds with the step of supporting the wiper blade with an elastic elonngated carrier that extends longitudinally and is self-biased into a pre-curved shape. The method continues with the step of engaging a connecting device, which is configured for connection with a wiper arm, with the carrier. The method proceeds with the step of adhesively joining a pair of subspoilers, which are constructed as separate pieces from one another and from the wiper blade, with the carrier on opposite longitudinal sides of the connecting device with an adhesive that is applied along less than a full longitudinal length of each respective subspoiler.

According to another aspect of the present invention, the joining step includes joining each subspoiler to the carrier in at least three discrete and spaced apart adhesive regions which are spaced apart from one another by non-adhesive regions.

Still a further aspect of the present invention provides for a windscreen wiper device including a longitudinally extending wiper blade of a flexible material for sealing against a windshield of a vehicle. The wiper device further includes an elastic, elongated carrier that is self-biased into a pre-curved shape and which extends longitudinally between opposite ends. The carrier operably supports and biases the wiper blade into a pre-curved configuration. End caps are engaged with the opposite ends of the carrier, and a connecting device is secured to the carrier for attachment to an oscillating wiper arm. A pair of subspoilers, which are constructed as separate pieces from one another and from the wiper blade, are arranged on longitudinally opposite sides of the connecting device. Each of the subspoilers is bonded with the carrier along less than a full longitudinal length of the respective subspoiler, is bonded with the connecting device or is bonded with one of the end caps.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a perspective and elevation view of a first exemplary embodiment of a windscreen wiper device;

FIG. 2 is a cross-sectional view taken along line 2-2 of the windscreen wiper device of FIG. 1;

FIG. 3 is a top elevation view of an exemplary carrier from the windscreen wiper device of FIG. 1;

FIG. 4 is a cross-sectional view taken along line 4-4 of the windscreen wiper device of FIG. 1;

FIG. 5 is a cross-sectional view taken along line 5-5 of the windscreen wiper device of FIG. 1; and

FIG. 6 is a cross-section view of a second exemplary embodiment of a windscreen wiper device.

### DESCRIPTION OF THE ENABLING EMBODIMENT

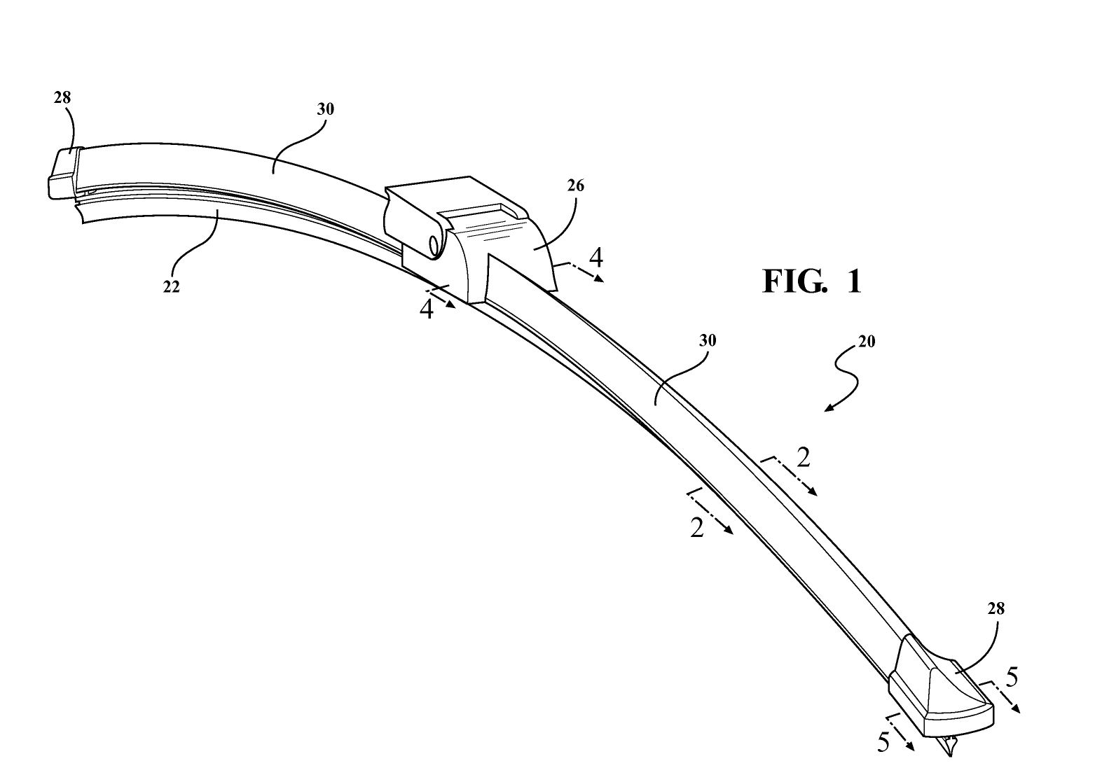

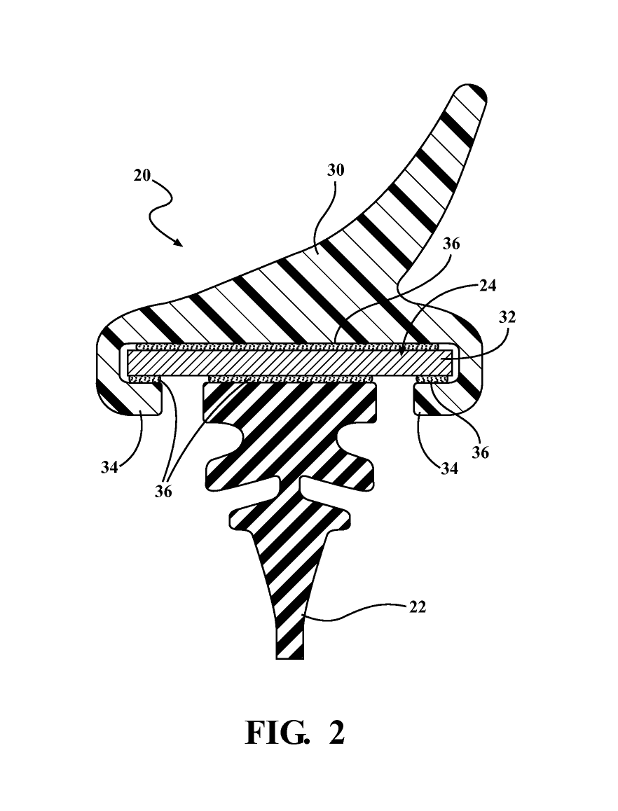

Referring to the Figures, wherein like numerals indicate corresponding parts throughout the several views, a first exemplary embodiment of a wiper blade assembly 20, or a windscreen wiper device, is generally shown in FIGS. 1 and 2. The windscreen wiper device has a wiper blade 22 (also known as a wiper strip or wiping element) which is made of a flexible material, such as a soft plastic or rubber. In use, the wiper blade 22 seals against the windshield of a vehicle to establish a seal therebetween for driving rain, snow, ice or other elements away from the windshield. The wiper blade assembly 20 additionally includes an elastic, elongated and spring-like carrier 24 which is self-biased into a pre-curved shape and which extends longitudinally between opposite ends. The carrier 24 operably supports the wiper blade 22 and is biased into a curved shape when in a resting condition. The carrier 24 is preferably made of metal, such as spring steel.

A connecting device 26 is secured to the carrier 24 at approximately a longitudinal mid-point of the carrier 24 for attachment to an oscillating wiper arm (not shown). The connecting device 26 could be configured for attachment to a range of different types of oscillating wiper arms including, for example, hook-style wiper arms, push button-style wiper arms, side pin-style wiper arms, etc.

A pair of end caps 28 are positioned at and joined with opposite longitudinal ends of the carrier 24. The wiper blade assembly 20 further includes a pair of subspoilers 30 which are constructed from separate pieces from one another and from the wiper blade 22 and are arranged on longitudinally opposite sides of the connecting device 26. More particularly, as shown in FIG. 1, the subspoilers 30 extend substantially from opposite sides of the connecting device 26 to the respective end caps 28 at the longitudinal ends of the carrier 24. The subspoilers 30 are each provided with an aerodynamic shape to impart a downforce on the wiper blade 22 to improve the seal between the wiper blade 22 and the windshield during operation of the wiper blade assembly 20. Each of the subspoilers 30 is made of a resiliently flexible material for bending with the carrier 24 element into the precurved shape and for bending and straightening during use as the wiper blade assembly 20 travels along a curved windshield. The subspoilers 30 are preferably made of a natural or synthetic rubber or of a polymeric material.

Referring now to FIG. 2, the carrier 24 of the first exemplary embodiment is a single strip 32 of metal which is adhesively joined or glued with a generally flat top surface of the wiper blade 22. As shown, the single strip 32 carrier 24 extends outwardly on opposite lateral sides of the wiper blade 22. When viewed in cross-section, the subspoiler 30 includes opposing claws 34 which engage around opposite lateral edges of the carrier 24. The base surface of each sub spoiler 30 is bonded to the carrier 24 along its lateral width between the claws 34 to establish a permanent connection between these components, which may provide increased resistance to unintentional detachment of the subspoiler 30. Specifically, in the exemplary embodiment, the bonding agent between the subspoiler 30 and the carrier 24 is an adhesive 36. However, it should be appreciated that the adhesive 36 between the subspoiler 30 and the carrier 24 could be a different kind of bonding agent other than adhesives including, for example, ultrasonic welding, laser welding, fusing, melting, etc.

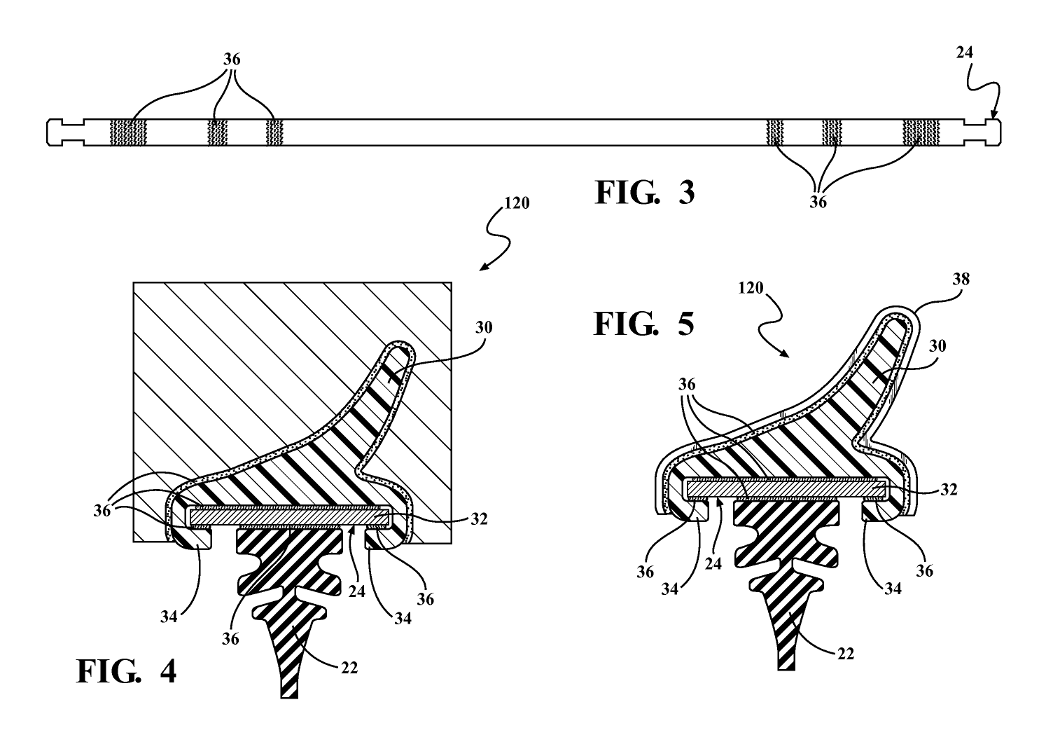

Referring now to FIGS. 1 and 3, the carrier 24 of the first exemplary embodiment is generally shown. The carrier 24 includes a plurality of spaced apart and discrete adhesive 36 regions for adhesively joining the sub spoiler 30 with the carrier 24. Specifically, in the exemplary embodiment, the carrier 24 includes three discrete adhesive 36 regions for joining the carrier 24 with one of the subspoilers 30 and three discrete adhesive 36 regions for joining the carrier 24 with the other subspoiler 30. As such, less than the full longitudinal length of each subspoiler 30 is adhesively joined with the carrier 24. The adhesive 36 could be any suitable adhesive 36 such as, for example, a glue or a double-sided tape. It should be appreciated that the adhesive 36 regions could alternately or additionally be applied to the subspoilers 30.

Referring now to FIG. 4, each of the subspoilers 30 of the first exemplary embodiment is also joined to the connecting device 26 with an adhesive 36 to restrict detachment therefrom. As shown, in this embodiment the adhesive 36 is applied to substantially the entire surface of contact between the subspoiler 30 and the connecting device 26. FIG. 5 also shows that in the first exemplary embodiment, each of the subspoilers 30 is joined to an end cap 28 with an adhesive 36 to resist detachment therefrom.

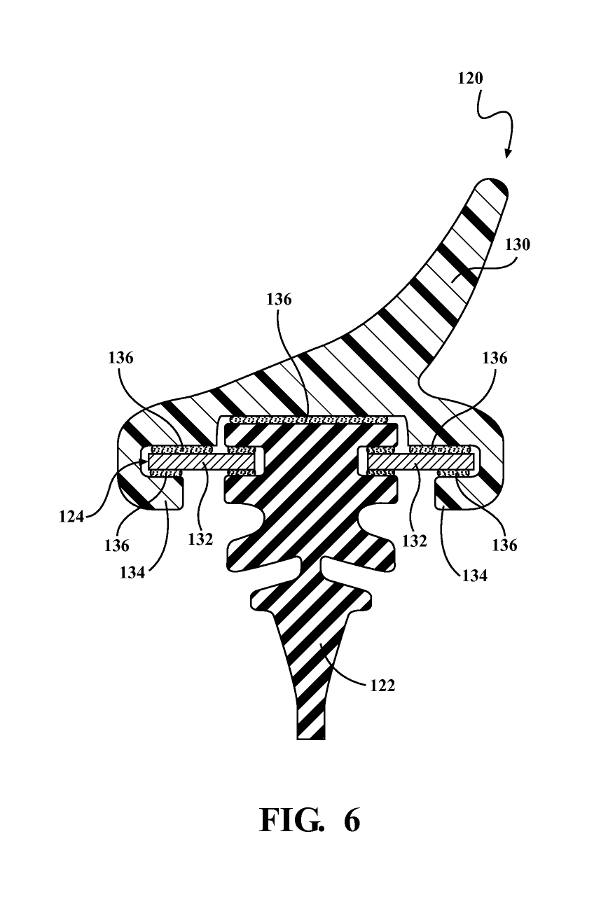

Referring now to FIG. 6 wherein like numerals, separated by a factor of, indicate corresponding parts with the above-described embodiment, a second exemplary embodiment of the wiper blade assembly 120 is generally shown. In this exemplary embodiment, the carrier 124 includes a pair of separately constructed metal strips 132 which are seated in oppositely facing grooves on the wiper blade 122. As such, the metal strips 132 are spaced laterally from one another and are joined together at adjacent ends by the end caps 128 (not shown in this Figure). As shown, the subspoiler 130 is joined with the two metal strips 132 of the carrier 124 with an adhesive 136, which is present both between the base surface of the subspoiler 130 and the metal strips 132 and also between the claws 134 and the metal strips 132. Additionally, in this exemplary embodiment, an adhesive 136 joins the subspoiler 130 with an upper surface of the wiper blade 122.

Another aspect of the present invention provides for a method of making a windscreen wiper device. The exemplary method includes the step of preparing a wiper blade 22 of a flexible material for sealing against a windshield to be cleaned. The exemplary method proceeds with the step of supporting the wiper blade 22 with an elastic, elongated carrier 24 that is self-biased into a pre-curved shape and which extends longitudinally between opposite ends with the wiper blade 22. The exemplary method continues with the step of engaging a connecting device 26, which is configured for connection with a wiper arm, with the carrier 24. The exemplary method proceeds with the step of adhesively joining a pair of subspoilers 30, which are constructed as separate pieces from one another and from the wiper blade 22, with the carrier 24 on opposite longitudinal sides of the connecting device 26 with an adhesive 36 that is applied along less than a full length of each respective subspoiler 30. The adhesive 36 may be applied in two or more discrete and spaced apart adhesive 36 regions. The carrier 24 may include one or two metal strips 32.

Obviously, many modifications and variations of the present invention are possible in light of the above teachings and may be practiced otherwise than as specifically described while within the scope of the appended claims.

What is claimed is:

1. A windscreen wiper device, comprising:
a longitudinally extending wiper blade of a flexible material for sealing against a windshield of a vehicle;
an elastic, elongated carrier that is self-biased into a pre-curved shape and which extends longitudinally between opposite ends, said carrier operably supporting and biasing said wiper blade into a pre-curved configuration;
a connecting device secured to said carrier for attachment to an oscillating wiper arm;
a pair of subspoilers constructed as separate pieces from one another and from said wiper blade and arranged on longitudinally opposite sides of said connecting device; and
each of said subspoilers being joined with said carrier along less than a full longitudinal length of the respective subspoiler with an adhesive.

2. The windscreen wiper device as set forth in claim 1 wherein each of said subspoilers is joined with said carrier in at least two adhesive regions which are spaced apart by a non-adhesive region.

3. The windscreen wiper device as set forth in claim 2 wherein each of said subspoilers is joined with said carrier in at least three discrete and spaced apart adhesive regions.

4. The windscreen wiper device as set forth in claim 1 further including a pair of end caps joined to opposite longitudinal ends of said carrier and longitudinally spaced from said connecting device.

5. The windscreen wiper device as set forth in claim 1 wherein each of said subspoilers substantially spans the space between said connecting device and one of said end caps.

6. The windscreen wiper device as set forth in claim 1 wherein said adhesive joining said subspoilers with said carrier is a glue.

7. The windscreen wiper device as set forth in claim 1 wherein each of said subspoilers has a base surface and a pair of claws which engage around opposite lateral sides of the carrier.

8. The windscreen wiper device as set forth in claim 7 wherein said base surface is adhesively joined to at least one of said wiper blade and said carrier.

9. The windscreen wiper device as set forth in claim 7 wherein said claws are adhesively joined to said carrier.

10. The windscreen wiper device as set forth in claim 1 wherein said carrier is made of two strips of metal received in side grooves of said wiper blade.

11. The windscreen wiper device as set forth in claim 1 wherein said carrier is made of a single strip of metal which is adhesively joined to the wiper blade.

12. A method of making a windscreen wiper device, comprising the steps of:
preparing a wiper blade of a flexible material for sealing against a windshield to be cleaned;
supporting the wiper blade with an elastic elongated carrier that extends longitudinally and is self-biased into a pre-curved shape;
engaging a connecting device with the carrier, the connecting device being configured for connection with a wiper arm;
adhesively joining a pair of subspoilers which are constructed as separate pieces from one another and from the wiper blade with the carrier on opposite longitudinal sides of the connecting device with an adhesive that is applied along less than a full longitudinal length of each respective subspoiler.

13. The method as set forth in claim 12 wherein the joining step includes joining each subspoiler to the carrier in at least two adhesive regions which are spaced apart from one another by a non-adhesive region.

14. The method as set forth in claim 13 wherein the joining step includes joining each subspoiler to the carrier in at least three discrete and spaced apart adhesive regions.

15. A windscreen wiper device, comprising:
a longitudinally extending wiper blade of a flexible material for sealing against a windshield of a vehicle;
an elastic, elongated carrier that is self-biased into a pre-curved shape and which extends longitudinally between opposite ends, said carrier operably supporting and biasing said wiper blade into a pre-curved configuration;
end caps engaged with said opposite ends of said carrier;
a connecting device secured to said carrier for attachment to an oscillating wiper arm;
a pair of subspoilers constructed as separate pieces from one another and from said wiper blade and arranged on longitudinally opposite sides of said connecting device; and
each of said subspoilers being bonded with said carrier along less than a full longitudinal length of the respective subspoiler or being bonded with said connecting device or being bonded with one of said end caps.
